(19) United States
(12) Patent Application Publication
(10) Pub. No.: US 2021/0213985 A1
(43) Pub. Date: Jul. 15, 2021

(54) MERGING TRANSPORTATION PODS ONTO TRANSPORTATION LINES

(71) Applicant: Hyperloop Technologies, Inc., Los Angeles, CA (US)

(72) Inventor: Dapeng Zhang, West Covina, CA (US)

(21) Appl. No.: 17/099,326

(22) Filed: Nov. 16, 2020

Related U.S. Application Data
(60) Provisional application No. 62/959,049, filed on Jan. 9, 2020.

(51) Int. Cl. B61L 27/00; G06N 20/00

(52) U.S. Cl. CPC B61L 27/0072; B61L 27/0027; G06N 20/00

(57) ABSTRACT

Merging transportation pods onto transportation lines. A method includes requesting movement information associated with a set of transportation pods that will pass a junction. The method also includes determining whether to merge from the second transportation line to the first transportation line via the junction at the first time based on the movement information. The method further includes merging from the second transportation line to the first transportation line at the junction at the first time, in response to determining that the first transportation pod should merge from the second transportation line to the first transportation line via the junction at the first time.

### CROSS-REFERENCE TO RELATED APPLICATIONS

This application claims the benefit of U.S. Provisional Patent Application No. 62/959,049, filed on Jan. 9, 2020. The disclosure of the above-referenced application is hereby incorporated by reference in its entirety.

### TECHNICAL FIELD

Aspects of the present disclosure relate to a transportation system, and more particularly, to merging transportation pods onto transportation lines.

### BACKGROUND

Transportation systems may include multiple transportation lines and multiple transportation pods that travel along the various transportation lines. The transportation lines may be directed or directional routes that allow transportation pods (e.g., vehicles) to travel between different locations in the transportation system. For example, a transportation line may be similar to links, tracks, or rails that allow transportation pods to travel to different locations (e.g., stops, stations, etc.) within the transportation system. The transportation pods may be capsules, vehicles, cars, or some other type of device that may move from one location to another. For example, the transportation pods may be similar to trains, although the transportation pods may not travel on tracks. The transportation pods may transport various things between the stops in the transportation system 100. For example, the transportation pods may transport (e.g., move, convey, etc.) passengers or items, such as products, goods, freight, merchandise, payloads, shipments, packets, etc., between different stops in the transportation system.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example transportation system, in accordance with one embodiment of the present disclosure.

FIG. 2 is a block diagram that illustrates an example transportation system, in accordance with one embodiment of the present disclosure.

FIG. 3 is a block diagram that illustrates an example transportation system, in accordance with one embodiment of the present disclosure.

FIG. 4 is a block diagram that illustrates an example transportation system, in accordance with one embodiment of the present disclosure.

FIG. 5 is a flow diagram of a method of merging a transportation pod onto a transportation line, in accordance with one embodiment of the present disclosure.

FIG. 6 is a flow diagram of a method of merging a transportation pod onto a transportation line, in accordance with one embodiment of the present disclosure.

FIG. 7 is a block diagram of an example computing device that may perform one or more of the operations described herein, in accordance with one embodiment of the present disclosure.

### DETAILED DESCRIPTION

As discussed above, transportation systems may include multiple transportation lines and multiple transportation pods that travel along the various transportation lines. The transportation pods may be capsules, vehicles, cars, or some other type of device that may move from one location to another. The transportation pods may transport various things between the stops in the transportation system 100. For example, the transportation pods may transport (e.g., move, convey, etc.) passengers or items, such as products, goods, freight, merchandise, payloads, shipments, packets, etc., between different stops in the transportation system. The transportation lines may be connected via junctions that allow transportation pods to merge from one transportation line to another.

The junctions in a transportation system may become an obstruction or barrier for high speed transit (e.g., a maglev transportation system, such as Hyperloop) because higher speeds may further increase the minimum distance between transportation pods to allow the transportation pod to operate safely. Because junctions can cause transportation pods to slow down and may decrease the efficiency of the transportation system, the use of cross-line operation may be reduced in the transportation system.

The present disclosure addresses the above-noted and other deficiencies by using shorter or smaller transportation pods in the transportation system. In addition, the different transportation pods may coordinate their behaviors, operation, speeds, etc., with each other (directly or via infrastructure nodes) to allow the transportation pods to merge not different transportation lines more quickly and efficiently, thus enable the use of cross-line operation in the transportation system. The use of cross-line operation in the transportation system may allow for more stops (e.g., destinations, stations, etc.) within the transportation system and may allow a transportation system to use more transportation lines within an area.

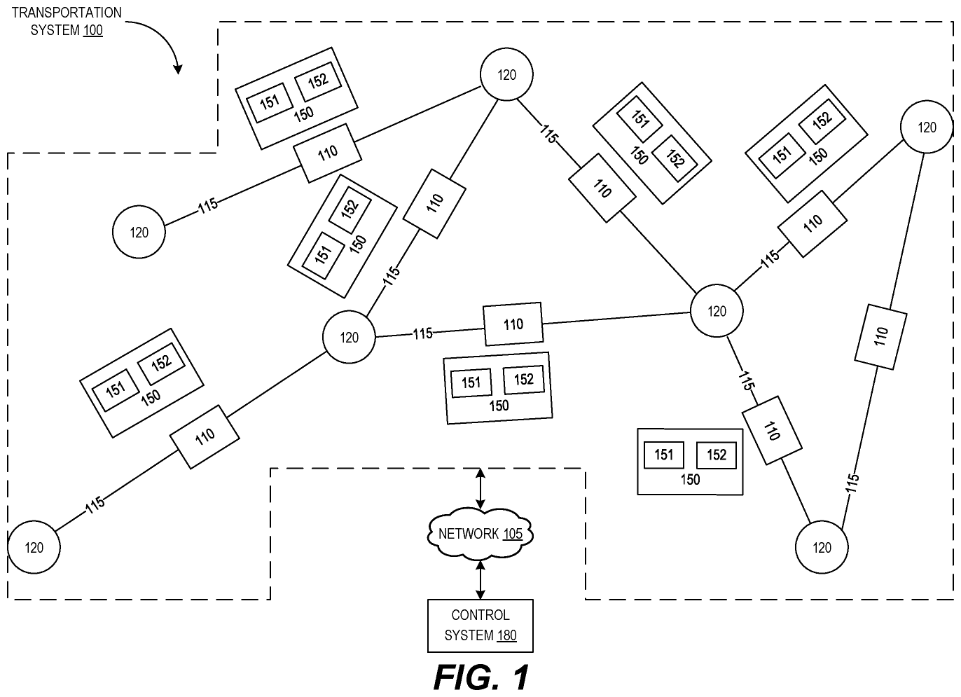

FIG. 1 is a block diagram that illustrates an example transportation system 100, in accordance with one embodiment of the present disclosure. The transportation system 100 includes transportation pods 110, transportation lines 115, and destinations 120. As discussed above, the transportation lines 115 may be directed or directional paths that allow transportation pods 110 (e.g., vehicles) to travel between the different destinations 120. For example, the transportation lines 115 may be similar to links, tracks, or rails that allow transportation pods 110 to travel to different locations (e.g., destinations 120) within the transportation system 110. In one embodiment, the transportation lines 115 may be tubes within which the transportation pods 110 may travel. For example, the transportation lines 115 may be vacuum sealed (or near vacuum sealed) tubes that include magnetic (e.g., electromagnetic) tracks. Different transportation lines 115 may be connected to each other via junctions between the transportation lines. A junction may be a location where two transportation lines converge or diverge. For example, a junction may allow a transportation pod 110 on a first transportation line to merge onto a second transportation line.

The transportation pods 110 may each be capsules, vehicles, cars, or some other type of device that may move from one location to another. For example, the transportation pods 110 may be similar to trains, although the transportation pods 110 may not travel on tracks. In one embodiment, transportation pods 110 may be a magnetic levitation (maglev) pod or capsule that travels along magnetic tracks located within a tube (e.g., a vacuum sealed or low air pressure tube). The transportation pods 110 may transport various things between the stops in the transportation system 100. For example, the transportation pods 110 may transport (e.g., move, convey, etc.) passengers between different stops in the transportation system 100. In another example, the transportation pods 110 may transport items, such as products, goods, freight, merchandise, payloads, shipments, packets, etc., between different stops in the transportation system. The transportation pods 110 may include multiple portions (e.g., multiple pods that are logically grouped or physically coupled together). The length of each of the transportation pods 110 may vary based on the needs or requirements of the transportation system 100 (e.g., may vary from less than ten meters to hundreds of meters). Transportation pods 110 may each include one or more of a light detection and ranging (LiDAR) device, a laser range finder, a camera (e.g., a video camera), a radio frequency device (e.g., a radar device), an ultrasonic sensor, etc, and/or other device that may be used for autonomous navigation and/or operation of the transportation pods 110.

The destinations 120 may be stops, stations, waypoints, etc., where passengers and/or cargo may be loaded onto the transportation pods 110. For example, the destinations 120 may be different cities, towns, metropolitan areas, etc., that are interconnected by the transportation lines 115. Although the present disclosure may refer to cities, towns, and/or metropolitan areas, the destinations 120 may be any location where a transportation 110 may stop (e.g., temporarily stop to load/unload passengers and/or cargo). For example, the destinations 120 may be stops (e.g., stations) within one city.

The infrastructure nodes 150 may be devices, systems, mechanisms, etc., that allow the transportation system 100 to detect, communicate with, and manage the transportation pods 110. The infrastructure nodes 150 may be positioned at various locations along the transportation lines 115. For example, there may be an infrastructure node 150 located every 10 meters, 50 meters, 100 meters, or some other appropriate distance along each of the transportation lines 115. The infrastructure nodes 150 may be placed at known or predetermined locations along the transportation lines 115 (e.g., the geographical locations of the infrastructure nodes 150 are known).

An infrastructure node 150 includes a sensor node 151. The sensor node 151 may include various devices, systems, mechanisms, etc., that allow the infrastructure node 150 to detect the location and/or speed of the transportation pods 110 as they travel through the transportation lines 115. For example, the sensor node 151 may include one or more of a radio frequency device (e.g., a radar device/system), a LiDAR device, a laser range finder, a camera (e.g., a video camera), an ultrasonic sensor, a Hall effect sensor, a presence sensor/detector (e.g., a device that detects the presence of a transportation pod 110), etc., that may be used to detect the speed of the transportation pods 110. Because the location of an infrastructure node 150 is known, the sensor node 151 allows an infrastructure node 150 to determine one or more of the speed and acceleration of a transportation pod at a certain point or location along a transportation line. The sensor node 151 may also be able to identify a transportation pod. For example, the sensor node 151 may include a radio-frequency identification (RFID) reader which may read an RFID tag located on a transportation pod. In another example, the sensor node 151 may determine an identifier for a transportation pod based on communications (e.g., messages) exchanged with the transportation pod via communication node 152.

An infrastructure node 150 also includes a communication node 152. The communication node 152 may allow the infrastructure node to communicate with one or more of a control system (e.g., a main control system, a command and control center, etc.), transportation pods 110, and other infrastructure nodes 150. For example, the communication node 152 may include a network interface (e.g., a wired network interface, a wireless network interface, etc.) that allows the infrastructure node 150 to communicate data (e.g., transmit and receive messages, packets, frames, etc.). Various communication protocols and technologies (e.g., cellular communications systems, Wi-Fi, Bluetooth, etc.) may be used by the communication node 152 to communicate data. The communication node 152 may communicate data about a transportation pod detected by a sensor node 151. For example, the transportation pod 110 passes an infrastructure node 150, the sensor node 151 may determine an identifier for the transportation pod 110 (e.g., a name, a serial number, a car number, etc.) and may determine the speed or acceleration of the transportation pod 110. The speed or acceleration of the transportation pod 110 may be referred to as movement information. The communication node 152 may transmit the movement information to other infrastructure nodes 150 or a control system, as discussed in more detail below.

The transportation system 100 also includes a control system 180. The control system 180 may control, manage, and monitor the operation of the transportation pod 110, as discussed in more detail below. The transportation system 100 may further include infrastructure nodes 150, as discussed in more detail below. Each infrastructure node 150 may include a sensor node 151 and a communication node 152. In one embodiment, the transportation system 100 may be a closed transportation system where the addition and removal of transportation pods within the transportation system 100 is controlled (e.g., controlled or managed by the control system 180).

The control system 180 and the infrastructure nodes 150 may be interconnected or coupled to each other (e.g., communicatively coupled) via a network 105. The network 105 may carry communications (e.g., data, message, packets, frames, other appropriate types or formats of data, etc.) between the infrastructure nodes and the control system 180. The network 105 may be a public network (e.g., the Internet), a private network (e.g., a local area network (LAN) or wide area network (WAN)), or a combination thereof. In one embodiment, the network 105 may include a wired or a wireless infrastructure, which may be provided by one or more wireless communications systems, such as a wireless fidelity (Wi-Fi) hotspot connected with the network and/or a wireless carrier system that can be implemented using various data processing equipment, communication towers (e.g. cell towers), etc. The transportation pods 110 may also be connected to each other, the infrastructure nodes 150, and the control system 180 via the network 105.

Each transportation pod 110 may include a pod control module (not illustrated in FIG. 1). In one embodiment, the pod control module may control the operation of a transportation pod 110. For example, the pod control module may increase or decrease the speed of the transportation pod 110, may cause a transportation pod 110 to stop at a station (e.g., a destination 120), etc. In another example, the pod control module may cause a transportation pod 110 to merge from one transportation line 115 to another transportation line 115 at a junction between the two transportation lines 115.

The pod control module of a transportation pod 110 may communicate with other transportation pods 110 (e.g., other pod control modules). For example, the pod control module may transmit the current speed and location of a transportation pod 110 to another transportation pod 110. This may be referred to as vehicle-vehicle (V-V) communications. The pod control module may also communicate with the infrastructure nodes 150. For example, the pod control module may transmit the current speed and location of the transportation pod 110 to the in structure nodes 150. This may be referred to as vehicle-infrastructure (V-I) communications. The pod control module may also transmit and/or receive messages or other data with other transportation pods 110 via the infrastructure nodes 150 (e.g., the messages/data may be forwarded by the infrastructure nodes 150). This may be referred to as vehicle-infrastructure-vehicle (V-I-V) communications.

In some embodiments, the pod control module of a transportation pod 110 may operate in conjunction and/or coordination with the control system 180 to control the operation of the transportation pod 110. For example, the control system 180 may communicate with the pod control module of a transportation pod 110 and inform the pod control module of other transportation pods 110 in the vicinity of a junction. The pod control module may increase/decrease the speed of the transportation pod to allow the transportation pod to merge safely via the junction.

In other embodiments, the control system 180 may control the operation of the transportation pods 110. For example, the control system 180 may determine when a transportation pod 110 should increase/decrease speed, should merge from one transportation line 115 to another transportation line 115, etc. The control system 180 may transmit messages or instructions to the control modules of the transportation pods 110 to cause the transportation pods to increase speed, decrease speed, merge, etc.

Each of the pod control modules and the control system 180 may include one or more computing devices. A computing device may include hardware such as processing devices (e.g., processors, central processing units (CPUs), memory (e.g., random access memory (RAM), storage devices (e.g., hard-disk drive (HDD), solid-state drive (SSD), etc.), and other hardware devices (e.g., sound card, video card, etc.). A computing device may include any suitable type of device or machine that has a programmable processor including, for example, server computers, desktop computers, laptop computers, tablet computers, smartphones, etc. In some examples, a computing device may include a single machine or may include multiple interconnected machines (e.g., multiple servers configured in a cluster).

In one embodiment, the pod control modules and the control system 180 may also include one or more virtual machines (VMs). A VM may be a software implementation of a machine (e.g., a software implementation of a computing device) that includes its own operating system (referred to as a guest OS) and executes application programs, applications, software. A VM may execute on a hypervisor which executes on top of the OS for a computing device (referred to as a host OS). The hypervisor may also be referred to as a virtual machine monitor (VMM). The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications.

In one embodiment, the pod control modules and the control system 180 may also include one or more containers. A container may be an isolated set of resources allocated to executing an application, software, and/or process independent from other applications, software, and/or processes. A container may execute on a container engine which executes on top of the OS for a computing device. The host OS (e.g., an OS of the computing device) may use namespaces to isolate the resources of the containers from each other. The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device.

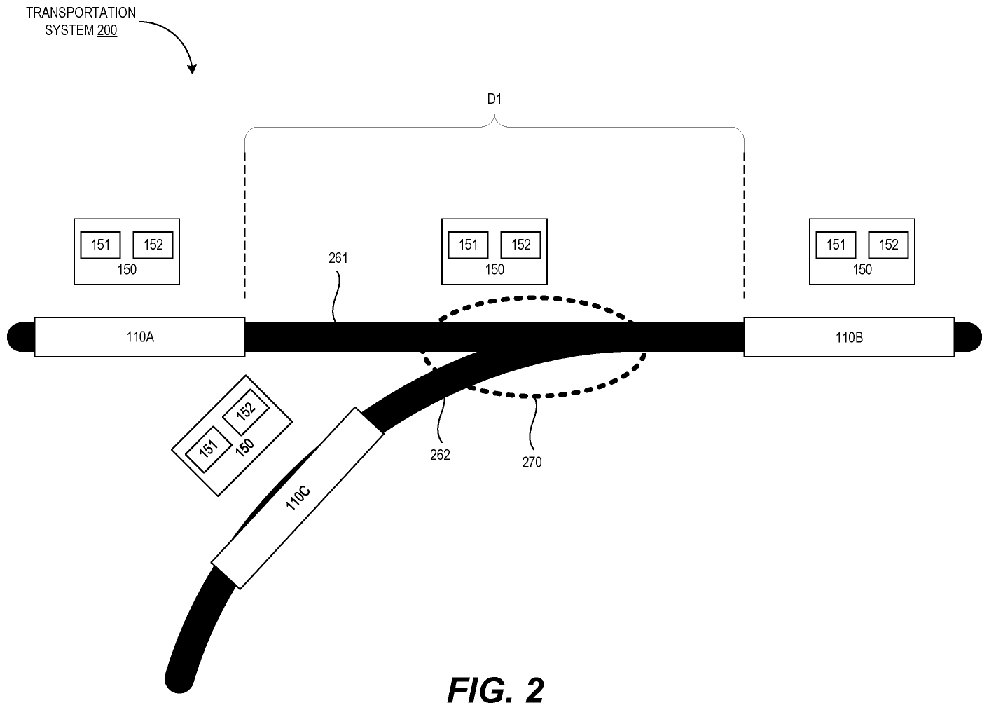

FIG. 2 is a block diagram that illustrates an example transportation system 200, in accordance with one embodiment of the present disclosure. The transportation system 200 includes a transportation line 261 and a transportation line 262. The transportation system 200 also includes infrastructure nodes 150. Each infrastructure node 150 may include a sensor node 151 and a communication node 152. The transportation system 200 further includes transportation pod 110A, transportation pod 110B, and transportation pod 110C. In one embodiment, the transportation system 200 may be a closed transportation system where the addition and removal of transportation pods within the transportation system 200 is controlled. For example, a control system (not illustrated in FIG. 1) may control the addition and remove if transportation pods within the transportation system 200.

The transportation line 261 and the transportation line 262 may each be directed or directional routes that allow transportation pods 110A, 110B, and 110C to travel between different locations in the transportation system. For example, the transportation line 261 and the transportation line 262 may be similar to links, tracks, or rails that allow transportation pods 110A, 110B, and 110C to travel to different locations (e.g., stops, stations, etc.) within the transportation system. The transportations lines 261 and 262 may be a subset of the transportation lines within the transportation system 200. For example, the transportation system 200 may include tens, hundreds, thousands, or some other appropriate number of transportation lines in other embodiments. In one embodiment, the transportation lines 261 and 262 may be tubes within which the transportation pods 110A, 110B, and 110C may travel. For example, the transportation lines 261 and 262 may be vacuum sealed (or near vacuum sealed) tubes that include magnetic (e.g., electromagnetic) tracks.

As discussed above, the transportation pods 110A, 110B and 110C may each be capsules, vehicles, cars, or some other type of device that may move from one location to another. In one embodiment, transportation pods 110A, 110B, and 110C may be a magnetic levitation (maglev) pod or capsule that travels along magnetic tracks located within a tube (e.g., a vacuum sealed or low air pressure tube). The transportation pods 110A, 110B, and 110C may transport various things between the stops in the transportation system 200. The transportation pods 110A, 110B, and 110C may include multiple portions (e.g., multiple pods that are logically grouped or physically coupled together). The length of each of the transportation pods 110A, 110B, and 110C may vary in different embodiments. For example, the length of each of the transportation pods 110A, 110B, and 110C may be hundreds or even thousands of meters (e.g., 900 meters, 1500 meters, etc.). Also as discussed above, the infrastructure nodes 150 may be devices, systems, mechanisms, etc., that allow the transportation system 200 to detect, communicate with, and manage the transportation pods 110A, 110B, and 110C. The infrastructure nodes 150 may be positioned at various locations along the transportation lines 161 and 162.

The transportation system 200 also includes a junction 270. A junction may be a location where two transportation lines converge or diverge. For example, junction 270 may be a location where the transportation line 262 converges or merges with transportation line 261. As illustrated in FIG. 1, transportation pod 110C may be merging onto transportation line 261 from transportation line 262 via the junction 270. In one embodiment, junctions in the transportation system 200 may reduce the efficiency of the transportation system 200. If the transportation line 261 is more crowded or is reaching capacity (e.g., there are many transportation pods travelling along transportation line 261), this may reduce the efficiency of the transportation system. Transportation pods may slow down to allow other transportation pods to safely merge onto a transportation line. For example, in order to maintain a minimum distance or headway (e.g., a minimum safe distance, the minimum distance for a transportation pod to come to a stop, etc.) transportation pods travelling along a transportation line may slow down from their cruising speed (or maximum speed) to allow another transportation pod to merged onto the transportation line.

Larger or longer transportation pods may further increase the inefficiencies in the transportation system 200. For example, longer transportation pods should have a longer minimum distance between the transportation pods for safety. This may further reduce the efficiency of the transportation line (e.g., the speed of the transportation pods, the number of transportation pods that can travel through a transportation line, etc.) because the transportation pods should maintain the longer minimum distance, due to the longer transportation pods. For example, if the transportation pods 110A, 110B, and 110C are 900 meters long, and travel at a speed of 20 meters per second (m/s), the transportation system may use a 90 second headway or a minimum distance of 1800 meters between the transportation pods 110A and 110B to allow the transportation pods 110A and 110B to stop safely in the event of a problem or emergency. The minimum distance is illustrated as distance D1. If transportation pod 110C (which may also be 900 meters long) merges onto the transportation line 261 from the transportation line 262, an additional 2700 meter gap or space should be created to allow all of the transportation pods 110A, 110B, and 110C to operate safely.

The junctions in a transportation system 200 may become an obstruction or barrier for high speed transit (e.g., a maglev transportation system, such as Hyperloop) because higher speeds may further increase the minimum distance between transportation pods to allow the transportation pod to operate safely. Although the signaling, switching, and interlocking technologies, mechanisms, systems, etc., have been used in other types of transportation systems (e.g., railroads), these technologies, mechanisms, systems are often not fast enough to achieve more efficient utilization of the transportation lines (e.g., to allow more transportation pods to simultaneously travel on the transportation lines in the transportation system 200). Thus, junctions may become bottlenecks in the transportation system.

Because junctions can cause transportation pods to slow down and may decrease the efficiency of the transportation system the use of cross-line operation may be reduced in the transportation system. Cross-line operation allows a transportation pod move across or use multiple transportation lines. Cross-line operation may provide various benefits to the transportation system 200. For example, it may reduce the number of transfers that a passenger or cargo makes when traveling to a destination. Rather than stopping at a station or stop on a first transportation line and moving to a different transportation pod on another transportation line, it would be quicker and more efficient to allow the same transportation pod to merge from the first transportation line to the second transportation line (e.g., to cross transportation lines). In some instances, an interchange station may allow a vehicle to move from one transportation line to another transportation line. However, the wait time at an interchange station in a traditional track-based transportation system (e.g., a railroad, a metropolitan rail system) may range from a few minutes to a few hours. Although an interchange station may allow a vehicle to move from one transportation line to another transportation line, the time spent at the interchange station may result in longer travel time as well as physical and mental exertion. Cross-line operation may also allow line based (e.g., track or tubed based) transportation systems to become a more preferred mode of transportation. This may divert passengers and cargo from congested roads to public transportation.

Due to the inefficiencies or slower speeds in the transportation system 200 caused by junctions, cross-line operation is often not common practice in a transportation system. Even when cross-line operation is used, the merges between the transportation lines are often located at non-busy segments or low speed segments of the transportation lines. This limits the benefits of cross-line operation and may cause the total travel time for a passenger or cargo to be longer. Thus, it may be useful and beneficial to allow transportation pods (or other vehicles) to merge across transpiration lines more quickly and efficiently via junctions in a high speed transportation system, as this would allow the use of cross-line operation in the transportation system 200.

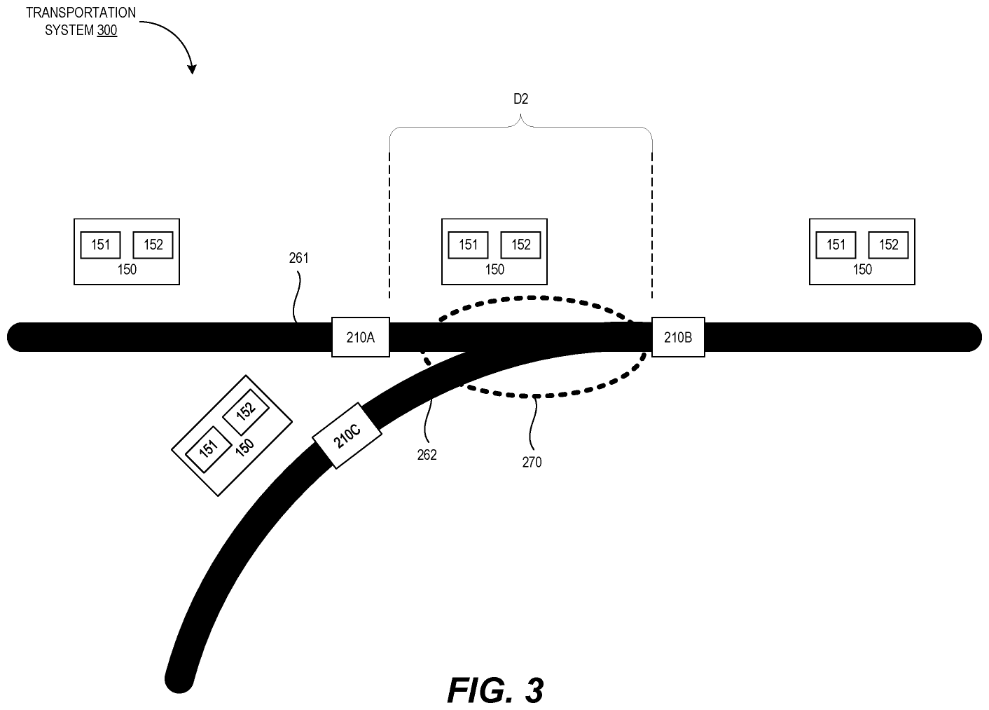

FIG. 3 is a block diagram that illustrates an example transportation system 300, in accordance with one embodiment of the present disclosure. The transportation system 300 includes a transportation line 261 and a transportation line 262. The transportation system 300 also includes infrastructure nodes 150. Each infrastructure node 150 may include a sensor node 151 and a communication node 152. The transportation system 300 further includes transportation pod 210A, transportation pod 210B, and transportation pod 210C. In one embodiment, the transportation system 300 may be a closed transportation system where the addition and removal of transportation pods within the transportation system 300 is controlled. For example, a control system (not illustrated in FIG. 3) may control the addition and remove if transportation pods within the transportation system 300.

The transportation line 261 and the transportation line 262 may each be directed or directional routes that allow transportation pods 210A, 210B, and 210C to travel between different stops, stations, etc., in the transportation system. The transportations lines 261 and 262 may be a subset of the transportation lines within the transportation system 300. In one embodiment, the transportation lines 261 and 262 may be tubes (e.g., vacuum sealed or low air pressure tubes) within which the transportation pods 210A, 210B, and 210C may travel.

The transportation pods 210A, 210B and 210C may each be capsules, vehicles, cars, or some other type of device that may move from one location to another. In one embodiment, transportation pods 210A, 210B, and 210C may be a magnetic levitation (maglev) pod or capsule that travels along magnetic tracks located within a tube (e.g., a vacuum sealed or low air pressure tube). The transportation pods 210A, 210B, and 210C may transport various things between the stops in the transportation system 300. The transportation pods 210A, 210B, and 210C may include multiple portions (e.g., multiple pods that are logically grouped or physically coupled together). The length of each of the transportation pods 210A, 210B, and 210C may be tens of meters (e.g., 20 meters, 30 meters, or some other appropriate length).

The infrastructure nodes 150 may be devices, systems, mechanisms, etc., that allow the transportation system 300 to detect, communicate with, and manage the transportation pods 210A, 210B, and 210C. The infrastructure nodes 150 may be positioned at various known or predetermined locations along the transportation lines 261 and 262. An infrastructure node 150 includes a sensor node 151. The sensor node 151 may include various devices, systems, mechanisms, etc., that allow the infrastructure node 150 to detect the location and/or speed of the transportation pods 210A, 210B, and 210C as they travel through the transportation lines 261 and 262. Because the location of an infrastructure node 150 is known, the sensor node 151 allows an infrastructure node 150 to determine one or more of the speed and acceleration of a transportation pod at a certain point or location along a transportation line. The sensor node 151 may also be able to identify a transportation pod. An infrastructure node 150 also includes a communication node 152. The communication node 152 may allow the infrastructure node to communicate with one or more of a control system (e.g., a main control system, a command and control center, etc.), transportation pods 210A, 210B, and 210C, and other infrastructure nodes 150. Various communication protocols and technologies (e.g., cellular communications systems, Wi-Fi, Bluetooth, etc.) may be used by the communication node 152 to communicate data. The communication node 152 may communicate data about a transportation pod detected by a sensor node 151. For example, the communication node 152 may transmit the movement information to other infrastructure nodes 150 or a control system, as discussed in more detail below.

The transportation system 300 also includes a junction 270. A junction may be a location where two transportation lines converge or diverge, as discussed above. As illustrated in FIG. 1, transportation pod 210C may be merging onto transportation line 261 from transportation line 262 via the junction 270 (e.g., the transportation pod 210C may be travelling/moving towards the right). In other embodiments, the transportation mode 210C may be merging onto transportation line 262 from transportation line 261 via junction 270 (e.g., the transportation pod 210C may be travelling/moving towards the right). As discussed above, junctions may reduce the efficiency of a transportation system because transportation pods may slow down to allow other transportation pods to safely merge onto a transportation line (e.g., to maintain a minimum safe distance). This problem is exacerbated further by high speed transportation pods (e.g., maglev pods or capsules) and longer transportation pods which further increases the distance between the transportation pods.

One method, technique, way, etc., for improving the efficiency of the transportation system 300 when junctions are used (which may enable cross-line operation), is to user smaller or shorter transportation pods along with communication, coordination, synchronization, etc., between the transportation pods and optionally a control center. This synchronization between transportation pods may be enabled by real-time communication between the transportation pods. For example, using the movement information gathered by an infrastructure node 150 or transportation pods, the speeds and movements of the transportations pods can be coordinate to more tightly control the spacing or distance between the transportation pods. In addition, allowing one transportation pod to know the locations, speeds, and movement patterns of other transportations pods may allow the transportation pod to adjust its speed or request the other transportation pods to adjust their speeds. This allows all of the transportation pods to adjust their speeds accordingly to accommodate the merging of transportation pods at junctions more quickly and efficiently. For example, the transportations pods may adjust their speeds accordingly to mitigate or reduce the impact that a merging transportation pod has on the flow of traffic through a transportation line.

As illustrated in FIG. 3, the transportation pods 210A, 210B, and 210C may be shorter than the transportation pods 110A, 110B, and 110C illustrated in FIG. 1. For example, the transportation pods 210A, 210B, and 210C may be 20 meters long and may travel at a speed of 20 meters per second (m/s). The transportation system 300 may a 45 second headway or a minimum distance of 900 meters between the transportation pods 210A and 210B to allow the transportation pods 210A and 210B to stop safely in the event of a problem or emergency. However, because the transportation pods 210A, 210B, and 210C are shorter than the transportation pods 110A, 110B, and 110C the headway may be reduced from 90 seconds to 45 seconds or a minimum distance of 900 meter between transportation pods. In addition, because of the shorter transportation pods, the gap or space that should be created to allow transportation pod 210C to merge onto the transportation line 261 may be 920 meters. This may provide a 66% reduction in the spacing between transportation pods when compared with the 90 second headway and 900 meter long transportation pods illustrated in FIG. 2.

In one embodiment, the transportation pod 210C may coordinate with the transportations pods 210A and 210B when the transportation pod 210C merges from the transportation line 262 from the transportation line 261. For example, the transportation pod 210C may transmit a message to the transportations pods 210A and 210B to request that the transportation pod 210A slow down and that the transportation pod 210B speed up to create a gap for the transportation pod 210C. These messages may be communicated directly between the transportation pods 210A, 210B, and 210C or may be relayed via the infrastructure nodes 150.

In one embodiment, the transportation pod 210C may be able to merge from transportation line 261 to transportation line 262 (or vice versa) without the mechanical movement of devices/components at the junction 270. For example, the transportation pod 210C may be able to merge from transportation line 261 to transportation line 262 (or vice versa) without the movement of tracks, rails, bumpers, etc. The movement of the transportation pod 210C may be caused and/or controlled by components, devices, systems, etc., located on the transportation pod 210C. The use of components, devices, systems, etc., located on the transportation pod 210C, rather than mechanical movement of devices/components at the junction 270 allows for faster and/or more efficient merging. For example, this allows the transportation pod 210C to merge onto the transportation line 261 in a manner similar to a car merging onto a highway, freeway, etc. The transportation pod 210C

By decreasing the size of the transportation pods 210A, 210B, and 210C and by coordinating between the transportation pods 210A, 210B, and 210C, the impact of a junction on the efficiency of the transportation system 300 may be reduced (e.g., may be greatly reduced). For example, smaller distances between the transportation pods may allow a higher number of transportation pods to use the transportation lines, even when other transportation pods are merging onto a transportation line. Increasing the efficiency of the transportation system 300 may allow the transportation system 300 to effectively use cross-line operation. As discussed above, cross-line operation allows a transportation pod move across or use multiple transportation lines. Cross-line operation may provide various benefits to the transportation system 300. For example, cross-line operation may reduce the travel time for passengers and cargo through the transportation system 300. Cross-line operation may also allow for rapid adoption of the transportation system. For example, cross-line operation may allow a transportation system to be more easily used for public transit purposes. The example, embodiments, implementations, etc., described herein may improve the efficiencies and operation of the transportation system 300 at junctions. This allows the transportation system 300 to use high-speed transportation vehicles (e.g., maglev pods or capsules) and junctions to provide or allow cross-line operation.

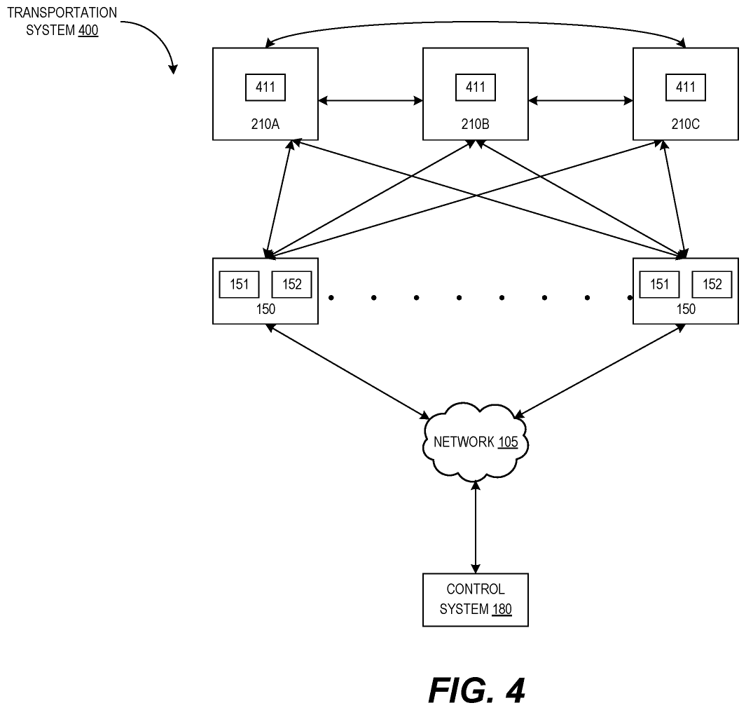

FIG. 4 is a block diagram that illustrates an example transportation system 400, in accordance with one embodiment of the present disclosure. As discussed above, the transportation system 400 may include multiple transportation lines (not illustrated in FIG. 4). The transportation lines may be connected to each other via junctions between the transportation lines. For example, a junction may allow a transportation pod on a first transportation line to merge onto a second transportation line. The transportation system 400 also includes a control system 180. The control system 180 may control, manage, and monitor the operation of the transportation pod 210A, 210B, and 210C, as discussed in more detail below. The transportation system 400 further includes infrastructure nodes 150. Each infrastructure node 150 may include a sensor node 151 and a communication node 152. The transportation system 400 further includes transportation pod 210A, transportation pod 210B, and transportation pod 210C. In one embodiment, the transportation system 400 may be a closed transportation system where the addition and removal of transportation pods within the transportation system 400 is controlled (e.g., controlled or managed by the control system 180). The transportation pods 210A-210C, the control system 180, and the infrastructure nodes 150 may be interconnected or coupled to each other (e.g., communicatively coupled) via network 105. The network 105 may carry communications (e.g., data, message, packets, frames, other appropriate types or formats of data, etc.) between the transportation pods 210A-210C, the control system 180, and the infrastructure nodes 150.

As discussed above, the transportation pods 210A, 210B and 210C may each be capsules, vehicles, cars, or some other type of device that may move from one location to another. In one embodiment, transportation pods 210A, 210B, and 210C may be a magnetic levitation (maglev) pod or capsule that travels along magnetic tracks located within a tube (e.g., a vacuum sealed or low air pressure tube). The transportation pods 210A, 210B, and 210C may transport various things between the stops in the transportation system 400. The transportation pods 210A, 210B, and 210C may include multiple portions (e.g., multiple pods that are logically grouped or physically coupled together). The length of each of the transportation pods 210A, 210B, and 210C may be a few meters (e.g., 5 meters, 10 meters, 20 meters, 30 meters, or some other appropriate length). Each transportation pod 210A, 210B, and 210C includes a control module 411. In one embodiment, the control module 411 may control or determine whether a transportation pod should merge onto a transportation line via a junction, as discuss in more detail below.

The infrastructure nodes 150 may be devices, systems, mechanisms, etc., that allow the transportation system 400 to detect, communicate with, and manage the transportation pods 210A, 210B, and 210C. The infrastructure nodes 150 may be positioned at various known or predetermined locations along the transportation lines 161 and 162. An infrastructure node 150 includes a sensor node 151. The sensor node 151 may include various devices, systems, mechanisms, etc., that allow the infrastructure node 150 to detect the location and/or speed of the transportation pods 210A, 210B, and 210C as they travel through the transportation lines 161 and 162. The sensor node 151 may also be able to identify a transportation pod. An infrastructure node 150 also includes a communication node 152. The communication node 152 may allow the infrastructure node to communicate (e.g., movement information) with one or more of a control system 180 (e.g., a main control system, a command and control center, etc.), transportation pods 210A, 210B, and 210C, and other infrastructure nodes 150. Various communication protocols and technologies (e.g., cellular communications systems, Wi-Fi, Bluetooth, etc.) may be used by the communication node 152 to communicate data.

As discussed above, the transportation pod 210C may be merging onto a first transportation line from a second transportation line. The control module 411 (of the transportation pod 210C) may request movement information associated with a set of transportation pods (e.g., transportation pods 210A and 210B) that will pass a junction at a first time (e.g., a point in time). The first time may be an estimated or a predicted time that the transportation pod 210C will merge onto the first transportation line (from the second transportation line). The first time may be determined based on the current speed of the transportation pod 210C and a distance between the transportation pod 210C and the junction. In one embodiment, the first time may be determined by the control module 411. For example, the control module 411 may be aware of the speed of the transportation pod 210C the distance between the transportation pod 210C and the junction. The control module 411 may determine the distance between the transportation pod 210C and the junction based on communications with the infrastructure nodes 150. For example, as the transportation pod 210A pass by an infrastructure node 150 and communicates with the infrastructure node, the control module 411 may determine the current location of the infrastructure node 150. The set of transportation pods (e.g., transportation pods 210A and 210B) may be within a threshold distance of the junction at the first time but may not currently be near the junction.

In one embodiment, the control module 411 may determine whether the transportation pod 210C should merge from the second transportation line to the first transportation line via the junction at the first time based on the movement information associated with the transportation pods 210A and 210C. The movement information may indicate the current speeds and locations of the transportation pods 210A and 210B. In one embodiment, the movement information may be collected or determined by the infrastructure nodes 150 (e.g., by the sensor nodes 151). For example, as the transportation pods 210A and 210B pass by infrastructure nodes 150 the infrastructure nodes 150 may determine the speed and location of the transportation pods 210A and 210B.

In one embodiment, the control module 411 (of transportation pod 110C) may merge the transportation pod 210C onto the first transportation line from the second transportation line via the junction at the first time, if the control module 411 determine that the transportation pod 210C should merge. For example, the control module 411 may cause the transportation pod 210C to merge onto the first transportation line.

In one embodiment, the control module 411 may merge the transportation pod 210C onto the first transportation line by activating one or more mechanisms, systems, devices, etc., on the transportation pod 210C that cause the transportation pod 210C to merge onto the first transportation line.

In one embodiment, the control module 411 may transmit a request for the movement information to the transportation pods 210A and 210B. For example, the control module 411 may transmit a request for the movement information directly to the transportation pods 210A and 210B. The control module 411 may also receive the movement information directly from the transportation pods 210A and 210B. This may be referred to as vehicle-vehicle (V-V) communications.

In one embodiment, the control module 411 may transmit a request for the movement information to one or more infrastructure nodes 150 along the second transportation line where the transportation pod 210C is travelling or located. The one or more infrastructure nodes 150 may obtain the movement information from the transportation pods 210A and 210B (e.g., may request the movement information from the transportation pods 210A and 210B) and may forward the movement information to the transportation pod 210C (e.g., to control module 411). The transportation pod 210C may receive the movement information and determine whether the transportation pod 210C should merge, as discussed above. This may be referred to as vehicle-infrastructure (V-I) communications.

In one embodiment, the request for the movement information may be forwarded to the transportation pods 210A and 210B via the infrastructure nodes 150 that are located around the transportation pods 210A and 210B. The control modules 411 of the transportation pods 210A and 210B may determine the speeds and locations of the transportation pods 210A and 210B and may transmit that information (e.g., the movement information) back to the infrastructure nodes 150. The infrastructure nodes 150 may forward the movement information back to the control module 411 of the transportation pod 210C. This may be referred to as vehicle-infrastructure-vehicle (V-I-V) communications.

In one embodiment, the control module 411 of the transportation pod 210C may merge the transportation pod 210C onto the first transportation line by transmitting a message to one or more of the transportation pods 210A and 210B, indicating that one or more of the transportation pods 210A and 210B should adjust their speed. For example, the transportation pod 210C may transmit messages to the transportation pods 210A and 210B indicating that the transportation pod 210A should slow down and the transportation pod 210B should speed up to create a larger gap or space to allow the transportation pod 210C to merge into the space between the transportation pods 210A and 210B. The messages to adjust speed may be transmitted directly between the transportation pods 210A, 210B, and 210C, or via the infrastructure nodes 150. The messages (to adjust speed) may also be communicated to transportation pods that are in front of the transportation pod 210B and behind the transportation pod 210A. For example, if there are multiple transportation pods on the first transportation pod in addition to the transportation pods 210A and 210B, the messages may help coordinate the speeds, operation, behavior, etc., of all the transportation pods to allow the transportation pod 210C to merge onto the first transportation line.

In one embodiment, the transportation pod 210C may merge onto the first transportation line at different locations with respect to the transportation pods 210A and 210B. This may be based on an analysis of the speeds and current locations of the transportation pods 210A, 210B, and 210C along the transportation lines. For example, if there is enough distance or time, the transportation pod 210A may slow down and the transportation pod 210B may speed up to allow the transportation pod 210C to merge at the junction between the transportation pods 210A and 210B. In another example, the transportation pods 210A and 210B and may both slow down to allow the transportation pod 210C to merge at the junction in front of the transportation pods 210A and 210B. In a further example, the transportation pods 210A and 210B may both speed up to allow the transportation pod 210C to merge at the junction behind transportation pods 210A and 210B.

In one embodiment, the control module 411 may determine that the transportation pod 210C should not merge onto the first transportation line at the first time. For example, the control module 411 may determine that there is not enough time for the transportation pods 210A and 210B to adjust their speeds to allow the transportation pod 210C to merge onto the first transportation line at the junction at the first time.

In one embodiment, the control module 411 may identify a second junction and determine second time when the transportation pod 210C should merge at the second junction. The second junction may couple the second transportation line with a third transportation line. The control module 411 may request additional movement information associated with other transportation pods that will pass the second junction at the second time. In another embodiment, control module 411 may determine second time when the transportation pod 210C should merge at the junction. The control module 411 may request additional movement information associated with other transportation pods that will pass the junction at the second time. This may allow the control module 411 to merge the transportation pod 210C even if the transportation pod 210C is unable to merge at the first junction or at the first time.

In one embodiment, the control system 180 may determine whether the transportation pod 210C should merge from the second transportation line to the first transportation line via the junction at the first time based on the movement information associated with the transportation pods 210A and 210C. The movement information may indicate the current speeds and locations of the transportation pods 210A and 210B. In one embodiment, the movement information may be collected or determined by the infrastructure nodes 150 (e.g., by the sensor nodes 151).

In one embodiment, the control system 180 (of transportation pod 110C) may cause the transportation pod 210C to merge onto the first transportation line from the second transportation line via the junction at the first time, if the control system 180 determines that the transportation pod 210C should merge. In one embodiment, the control system 180 may cause the transportation pod 210C to merge onto the first transportation line by transmitting a message indicating that the transportation pod 210C should activate one or more mechanisms, systems, devices, etc., on the transportation pod 210C that cause the transportation pod 210C to merge onto the first transportation line.

In one embodiment, the control system 180 may transmit a request for the movement information to the transportation pods 210A and 210B. For example, the control system 180 may transmit a request for the movement information directly to the transportation pods 210A and 210B. The control system 180 may also receive the movement information directly from the transportation pods 210A and 210B.

In one embodiment, the control system 180 may transmit a request for the movement information to one or more infrastructure nodes 150 along the first transportation line where the transportation pods 210A and 210B are travelling or located. The one or more infrastructure nodes 150 may obtain the movement information from the transportation pods 210A and 210B and may forward the movement information to the control system 180. The control system 180 may receive the movement information and determine whether the transportation pod 210C should merge, as discussed above.

In one embodiment, the request for the movement information may be forwarded to the transportation pods 210A and 210B via the infrastructure nodes 150 that are located around the transportation pods 210A and 210B. The control modules 411 of the transportation pods 210A and 210B may determine the speeds and locations of the transportation pods 210A and 210B and may transmit that information (e.g., the movement information) back to the infrastructure nodes 150. The infrastructure nodes 150 may forward the movement information back to the control system 180.

In one embodiment, the control system 180 of the transportation pod 210C may merge the transportation pod 210C onto the first transportation line by transmitting a message to one or more of the transportation pods 210A and 210B, indicating that one or more of the transportation pods 210A and 210B should adjust their speed. The messages to adjust speed may be transmitted directly between the transportation pods 210A, 210B, and 210C, or via the infrastructure nodes 150. The messages (to adjust speed) may also be communicated to transportation pods that are in front of the transportation pod 210B and behind the transportation pod 210A.

In one embodiment, the transportation pod 210C may merge onto the first transportation line at different locations with respect to the transportation pods 210A and 210B, based on an analysis of the speeds and current locations of the transportation pods 210A, 210B, and 210C along the transportation lines.

In one embodiment, the control system 180 may determine that the transportation pod 210C should not merge onto the first transportation line at the first time. The control system 180 may identify a second junction and determine second time when the transportation pod 210C should merge at the second junction. The second junction may couple the second transportation line with a third transportation line. The control system 180 may request additional movement information associated with other transportation pods that will pass the second junction at the second time. The control system 180 may also determine second time when the transportation pod 210C should merge at the junction. The control system 180 may request additional movement information associated with other transportation pods that will pass the junction at the second time. This may allow the control system 180 to merge the transportation pod 210C even if the transportation pod 210C is unable to merge at the first junction or at the first time.

In one embodiment, each control module 411 may operate autonomously. For example, each control module 411 may include one or more machine learning models, artificial intelligence models, neural networks, applications, etc., that may allow the control module 411 merge onto and/or merge out of various junctions automatically. For example, the based on data (e.g., messages, packets, etc.) received from the infrastructure nodes 150 and other transportation pods, the control module 411 can automatically control the transportation pod (e.g., 210A, 210B, 210C, etc.) to merge onto and/or merge out of a junction. The control module 411 in each transportation pod allows each transportation pod to operate autonomously without input from the control system 180.

In addition, although the embodiments, implementations, and/or examples described herein may refer to a certain number of transportation pods, any number of transportation pods may be present in the transportation systems described herein. For example, there may be hundreds, thousands, millions, or some other appropriate number of transportation pods traveling within a transportation system. Furthermore, any number of transportation pods may merge onto and/or merge out of a junction (e.g., merge form one transportation line to another transportation line). For example, hundreds, thousands, or tens of thousands of transportation pods may merge onto/out of a junction every hour, few hours, day, or some other appropriate period of time.

Each of the control modules 411 and the control system 180 may include one or more computing devices. A computing device may include any suitable type of device or machine that has a programmable processor including, for example, server computers, desktop computers, laptop computers, tablet computers, smartphones, etc. In some examples, a computing device may include a single machine or may include multiple interconnected machines (e.g., multiple servers configured in a cluster). The control modules 411 and the control system 180 may also include one or more virtual machines (VMs), containers, and/or other virtual environments.

As discussed above, decreasing the size of the transportation pods 210A, 210B, and 210C and coordinating the operation, behaviors, and speeds of the transportation pods 210A, 210B, and 210C, may decrease the impact of a junction on the efficiency of the transportation system 400. Increasing the efficiency of the transportation system 400 may allow the transportation system 400 to effectively use cross-line operation which may provide various benefits to the transportation system 400. This allows the transportation system 200 to use high-speed transportation vehicles (e.g., maglev pods or capsules) and junctions to provide or allow cross-line operation.

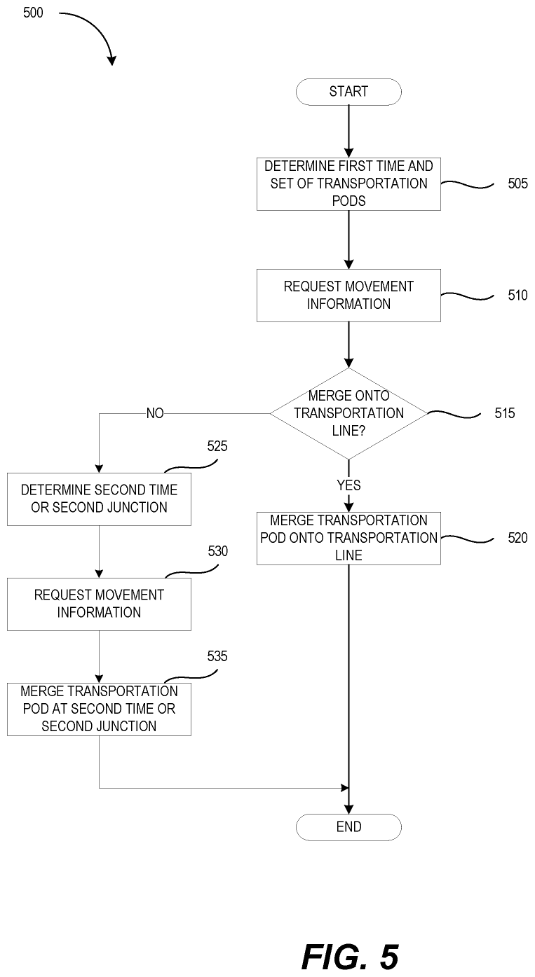

FIG. 5 is a flow diagram of a process 500 of merging a transportation pod (e.g., a first transportation pod) onto a transportation line, in accordance with one embodiment of the present disclosure. Process 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the process 500 may be performed by one or more of a control module and a computing device.

The process 500 begins at block 505, where the process 500 may determine a first time and a set of transportation pods that may be located at a junction at the first time. The process 500 may determine the first time based on the speed and location of the first transportation pod. At block 510, the process 500 may request movement information associated with the set of transportation pods. For example, the process 500 may request the speeds and locations for set of transportation pods. The request for the movement information and the movement information may be communicated directly between the transportation pods or via communication nodes (e.g., infrastructure nodes).

At block 515, the process 500 may determine whether the first transportation pod should merge onto the transportation line based on the movement information. If the process 500 determines that the first transportation pod should merge onto the transportation line, the process 500 may merge the transportation mode onto the transportation line. For example, the process 500 may activate one or more mechanisms in the first transportation pod to cause the first transportation pod to merge onto the transportation line.

If the process 500 determine that the first transportation pod should not merge onto the transportation line, the process 500 may determine a second time or a second junction at block 525. For example, the process 500 may identify a second time to merge at the junction or a second time to merge at a second junction. The process 500 may request movement information for a second set of transportation pods that may be located around the junction or the second junction at the second time at block 530. At block 535, the process 500 may merge the first transportation pod at the second time via the junction or the second junction.

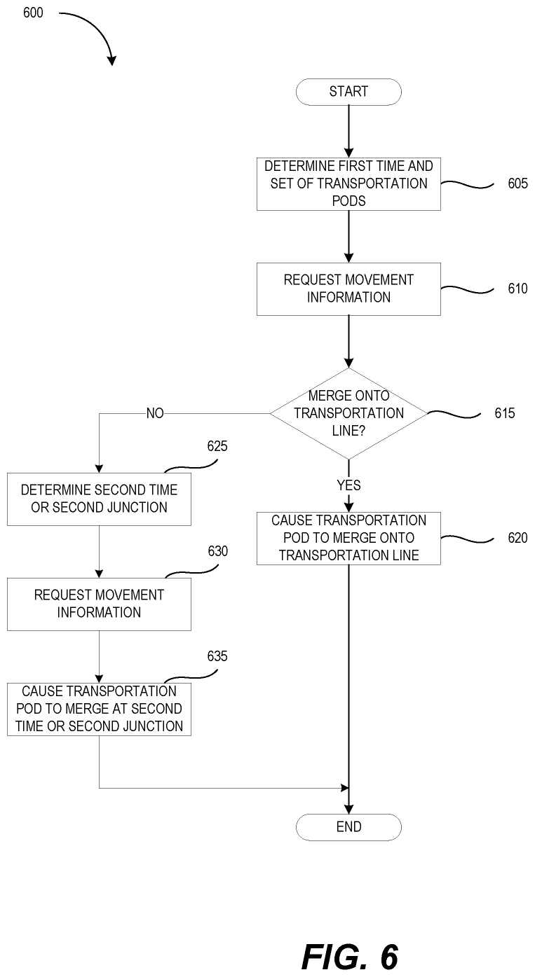

FIG. 6 is a flow diagram of a process 600 of forwarding a packet in accordance with some embodiments. Process 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the process 600 may be performed by one or more of a control system and a computing device.

The process 600 begins at block 605, where the process 600 may determine a first time and a set of transportation pods that may be located at a junction at the first time. The process 600 may determine the first time based on the speed and location of the first transportation pod. At block 610, the process 600 may request movement information associated with the set of transportation pods. For example, the process 600 may request the speeds and locations for set of transportation pods. The request for the movement information and the movement information may be communicated directly between the transportation pods or via communication nodes (e.g., infrastructure nodes).

At block 615, the process 600 may determine whether the first transportation pod should merge onto the transportation line based on the movement information. If the process 600 determines that the first transportation pod should merge onto the transportation line, the process 600 may merge the transportation mode onto the transportation line. For example, the process 600 may activate one or more mechanisms in the first transportation pod to cause the first transportation pod to merge onto the transportation line.

If the process 600 determine that the first transportation pod should not merge onto the transportation line, the process 600 may determine a second time or a second junction at block 625. For example, the process 600 may identify a second time to merge at the junction or a second time to merge at a second junction. The process 600 may request movement information for a second set of transportation pods that may be located around the junction or the second junction at the second time at block 630. At block 635, the process 600 may merge the first transportation pod at the second time via the junction or the second junction.

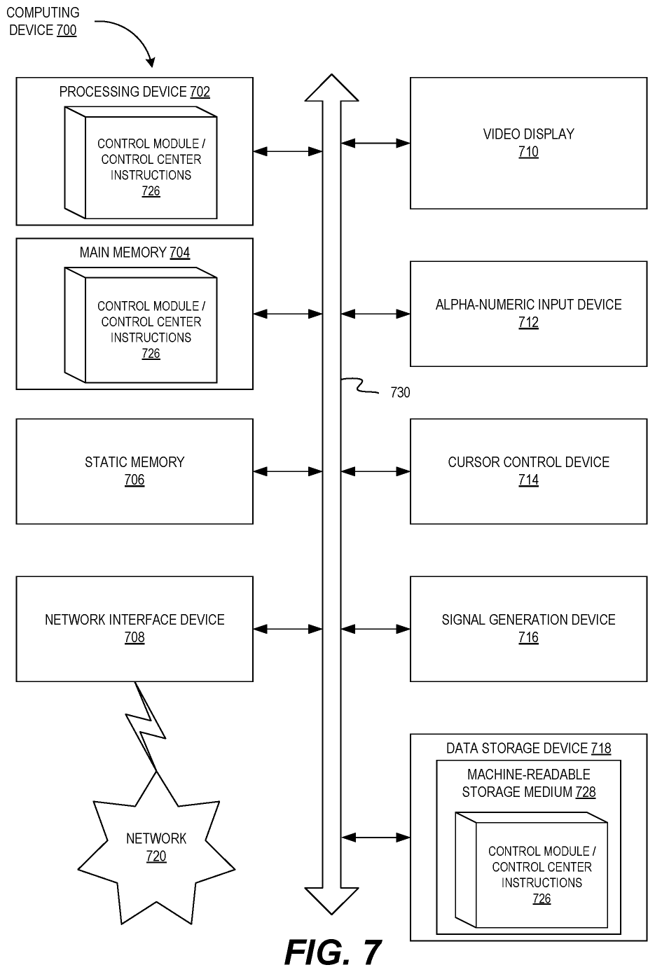

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein. In some embodiments, the computing device 700 may be one or more of an access point and a packet forwarding component.

The example computing device 700 may include a processing device (e.g., a general purpose processor, a PLD, etc.) 702, a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions 726 implementing one or more of a control module or a control system, may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “requesting,” “determining,” “merging,” “activating,” “transmitting,” “receiving,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
requesting, by a first transportation pod, movement information associated with a set of transportation pods that will pass a junction at a first time, wherein:
the junction comprises a location where a first transportation line and a second transportation line merge;
the set of transportation pods will be located on the first transportation line at the first time; and
the set of transportation pods will be located within a threshold distance of the junction at the first time;
determining, by the first transportation pod, whether to merge from the second transportation line to the first transportation line via the junction at the first time based on the movement information;
in response to determining that the first transportation pod should merge from the second transportation line to the first transportation line via the junction at the first time, merging, by the first transportation pod, from the second transportation line to the first transportation line at the junction at the first time.

2. The method of claim 1, wherein merging from the second transportation line to the first transportation line comprises:
activating one or more mechanisms on the first transportation pod to cause the first transportation pod to merge from the second transportation line to the first transportation line.

3. The method of claim 1, wherein requesting the movement information comprises:
transmitting a request for the movement information to the set of transportation pods.

4. The method of claim 1, wherein requesting the movement information comprises:
transmitting a request for the movement information to one or more communication nodes along the second transportation line; and
receiving the movement information via the one or more communication nodes along the second transportation line.

5. The method of claim 4, wherein:
the request for the movement information is forwarded by the one or more communication nodes from the first transportation pod to the set of transportation pods; and
the movement information is forwarded by the one or more communication nodes from the set of transportation pods to the first transportation pod.

6. The method of claim 1, further comprising:
determining the first time based on a speed of the first transportation pod and a distance between the first transportation pod and the junction;
determining the set of transportation pods based on the first time.

7. The method of claim 1, wherein merging from the second transportation line to the first transportation line comprises:
transmitting a message to a second transportation pod of the set of transportation pods, wherein the message indicates to the second transportation pod to change speed.

8. The method of claim 1, wherein merging from the second transportation line to the first transportation line comprises:
merging from the second transportation line to the first transportation line between a second transportation pod of the set of transportation pods and a third transportation pod of the set of transportation pods.

9. The method of claim 1, wherein merging from the second transportation line to the first transportation line comprises:
merging from the second transportation line to the first transportation line before or after a second transportation pod of the set of transportation pods and a third transportation pod of the set of transportation pods pass the junction.

10. The method of claim 1, further comprising:
in response to determining that the first transportation pod should merge from the second transportation line to the first transportation line via the junction at the first time:
requesting, by the first transportation pod, a second movement information associated with a second set of transportation pods that will pass the junction at a second time; or
requesting, by the first transportation pod, a third movement information associated with a third set of transportation pods that will pass a second junction at a third time.

11. A method, comprising:
requesting, by a control system, movement information associated with a set of transportation pods that will pass a junction at a first time, wherein:
the junction comprises a location where a first transportation line and a second transportation line merge;
the set of transportation pods will be located on the first transportation line at the first time; and
the set of transportation pods will be located within a threshold distance of the junction at the first time;
determining, by the control system, whether a first transportation pod should merge from the second transportation line to the first transportation line via the junction at the first time based on the movement information;
in response to determining that the first transportation pod should merge from the second transportation line to the first transportation line via the junction at the first time, causing the first transportation pod to merge from the second transportation line to the first transportation line at the junction at the first time.

12. The method of claim 11, wherein causing the first transportation pod to merge from the second transportation line to the first transportation line comprises:
transmitting a message to the first transportation pod to activate one or more mechanisms on the first transportation pod to cause the first transportation pod to merge from the second transportation line to the first transportation line.

13. The method of claim 11, wherein requesting the movement information comprises:
transmitting a request for the movement information to the set of transportation pods.

14. The method of claim 1, wherein requesting the movement information comprises:
transmitting a request for the movement information to one or more communication nodes along the second transportation line; and
receiving the movement information via the one or more communication nodes along the second transportation line.

15. The method of claim 14, wherein:
the request for the movement information is forwarded by the one or more communication nodes from the first transportation pod to the set of transportation pods; and
the movement information is forwarded by the one or more communication nodes from the set of transportation pods to the first transportation pod.

16. The method of claim 11, further comprising:
determining the first time based on a speed of the first transportation pod and a distance between the first transportation pod and the junction;
determining the set of transportation pods based on the first time.

17. The method of claim 11, wherein causing the first transportation pod to merge from the second transportation line to the first transportation line comprises:
transmitting a message to a second transportation pod of the set of transportation pods, wherein the message indicates to the second transportation pod to change speed.

18. The method of claim 11, wherein causing the first transportation pod to merge from the second transportation line to the first transportation line comprises:
causing the first transportation pod to merge from the second transportation line to the first transportation line between a second transportation pod of the set of transportation pods and a third transportation pod of the set of transportation pods.

19. The method of claim 11, wherein merging from the second transportation line to the first transportation line comprises:
causing the first transportation pod to merge from the second transportation line to the first transportation line before or after a second transportation pod of the set of transportation pods and a third transportation pod of the set of transportation pods pass the junction.

20. A transportation pod, comprising:
a memory; and
a processing device coupled to the memory, the processing device configured to:
request movement information associated with a set of transportation pods that will pass a junction at a first time, wherein:
the junction comprises a location where a first transportation line and a second transportation line merge;
the set of transportation pods will be located on the first transportation line at the first time; and
the set of transportation pods will be located within a threshold distance of the junction at the first time;
determine whether to merge from the second transportation line to the first transportation line via the junction at the first time based on the movement information;
in response to determining that the transportation pod should merge from the second transportation line to the first transportation line via the junction at the first time, merge from the second transportation line to the first transportation line at the junction at the first time.
